(19) United States
(12) Patent Application Publication
(10) Pub. No.: US 2009/0060209 A1
(43) Pub. Date: Mar. 5, 2009

(54) Audio-signal processing apparatus and method

(75) Inventor: Hiroyuki Takeishi, Yokohama-shi (JP)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(73) Assignee: Victor Company of Japan, Ltd. a corporation of Japan, Yokohama-shi (JP)

(21) Appl. No.: 12/229,952

(22) Filed: Aug. 28, 2008

(30) Foreign Application Priority Data
Aug. 31, 2007 (JP) JP 2007-226294
Jun. 24, 2008 (JP) JP 2008-164164

(51) Int. Cl. H04R 5/00

(52) U.S. Cl. 381/17

(57) ABSTRACT

Each of audio signals divided into several frequency bands are amplified per frequency band in accordance with gain characteristics that covers a sound-level range from a lowest level to a highest level of each signal. The range has a low range from the lowest level to a first level, a high range from a second level to the highest level, and an intermediate range from the first to second levels between the low and high ranges. The intermediate range has a transition point having a sound level higher than the first level but lower than the second level. Each signal is amplified such that a sound level of each signal is increased from the first level to the sound level of the transition point and then lowered from the sound level of the transition point to the second level in the intermediate range in accordance with the gain characteristics. The amplified audio signals are added and outputted.

### CROSS-REFERENCE TO RELATED APPLICATIONS

This application is based on and claims the benefit of priority from the prior Japanese Patent Application No. 2007-226294 filed on Aug. 31, 2007 and No. 2008-164164 filed on Jun. 24, 2008, the entire content of which is incorporated herein by reference.

### BACKGROUND OF THE INVENTION

The present invention relates to an audio-signal processing apparatus and method. Particularly, this invention relates to an audio-signal processing apparatus and method that reproduce sounds at an appropriate sound level.

When a listener listens to sounds through speakers or headphones, he or she rarely feels tired of listening when sounds are given off from the speakers or headphones at an appropriate sound level. It is thus preferable for audio equipment to reproduce sounds at an appropriate sound level. It is, however, not preferable for the audio equipment to degrade music reproducibility even if the sounds are reproduced at an appropriate sound level. The music reproducibility is defined that music can be reproduced as exactly as possible as created by musical artists.

Known audio-signal processing apparatuses are disclosed in, for example, Japanese Patent No. 3373103, Japanese Un-examined Patent Publication No. 2002-281599, and Japanese Un-examined Patent Publication No. 2000-22469. The first two documents teach signal processing with band-width filtering to divide an audio signal into several frequency bands. The last one teaches audio signal processing with enhanced transient response characteristics.

These known audio-signal processing apparatuses give sounds at a relatively appropriate sound level, however, have a problem of degrading the music reproducibility.

### SUMMARY OF THE INVENTION

A purpose of the present invention is to provide an audio-signal processing apparatus and method that reproduce sounds at an appropriate sound level without degrading the music reproducibility.

The present invention provides an audio signal processing apparatus comprising: band-division filters that divide a first audio signal into a plurality of frequency bands and output second audio signals in the respective frequency bands; sound-level amplifiers that amplify the second audio signals in the respective frequency bands in accordance with gain characteristics that covers a sound-level range from a lowest sound level to a highest sound level of each second audio signal, the sound-level range having a low sound level range from the lowest sound level to a first specific sound level, a high sound level range from a second specific sound level to the highest sound level, and an intermediate sound-level range from the first to second specific sound levels between the low and high sound level ranges, the intermediate sound-level range having a transition point having a sound level higher than the first specific sound level but lower than the second specific sound level, in which each second audio signal is amplified by the corresponding sound-level amplifier such that a sound level of each second audio signal is increased from the first specific sound level to the sound level of the transition point and then lowered from the sound level of the transition point to the second specific sound level in the intermediate sound-level range in accordance with the gain characteristics, and an adder to add the second audio signals thus amplified and output the added second audio signals as a third audio signal.

Moreover, the present invention provides an audio signal processing method comprising the steps of: dividing a first audio signal into a plurality of frequency bands and outputting second audio signals in the respective frequency bands; amplifying the second audio signals in the respective frequency bands in accordance with gain characteristics that covers a sound-level range from a lowest sound level to a highest sound level of each second audio signal, the sound-level range having a low sound level range from the lowest sound level to a first specific sound level, a high sound level range from a second specific sound level to the highest sound level, and an intermediate sound-level range from the first to second specific sound levels between the low and high sound level ranges, the intermediate sound-level range having a transition point having a sound level higher than the first specific sound level but lower than the second specific sound level, in which each second audio signal is amplified in the corresponding frequency band such that a sound level of each second audio signal is increased from the first specific sound level to the sound level of the transition point and then lowered from the sound level of the transition point to the second specific sound level in the intermediate sound-level range in accordance with the gain characteristics, and adding the second audio signals thus amplified and outputting the added second audio signals as a third audio signal.

### BRIEF DESCRIPTION OF DRAWINGS

FIG. 1 shows a block diagram representing a first embodiment of audio-signal processing apparatus, according to the present invention;

FIG. 2 shows a block diagram of a sound-level amplifier for each of several frequency bands in the first embodiment, according to the present invention;

FIG. 3 shows change in an output audio signal as a function of an input audio signal for explaining amplification at the sound-level amplifier in each frequency band, according to the present invention;

FIG. 4 shows the audible characteristics with an audible sound-level range in which ordinary people can hear sounds;

FIGS. 5A to 5E show several gain characteristics for the sound-level amplifiers in several frequency bands, according to the present invention;

FIG. 6 shows several waveforms for explaining a transient-response characteristics application process at the sound-level amplifiers, according to the present invention;

FIG. 7 shows Table 1 listing exemplary attack and release times for the sound-level amplifiers, according to the present invention;

FIG. 8 shows a block diagram representing a second embodiment of audio-signal processing apparatus, according to the present invention;

FIG. 9 shows Table 2 indicating minimum and maximum gains for CD and DVD in the second embodiment, according to the present invention;

FIG. 10 shows Table 3 indicating initial and standard gains for sound-level amplifiers in the second embodiment, according to the present invention;

FIG. 11 shows an exemplary waveform of an audio signal, which illustrates determination of the dynamic range in the second embodiment, according to the present invention;

FIG. 12 shows a block diagram of a sound-level amplifier for each of several frequency bands in the second embodiment, according to the present invention;

FIG. 13 shows a block diagram representing a third embodiment of audio-signal processing apparatus, according to the present invention;

FIG. 14 shows Table 4 listing several levels of gain settable at the sound-level amplifiers depending on the genre of the contents carried by input audio signals in the third embodiment, according to the present invention;

FIG. 15 shows a block diagram representing a fourth embodiment of audio-signal processing apparatus, according to the present invention;

FIG. 16 shows Table 5 listing several levels of gain settable at the sound-level amplifiers depending on the listening mode in the fourth embodiment, according to the present invention; and

FIG. 17 shows an exemplary block diagram of auditory-characteristics measuring equipment, according to the present invention.

### DETAILED DESCRIPTION OF PREFERRED EMBODIMENT

Several preferred embodiments of audio-signal processing apparatus and method will be disclosed with reference to the attached drawings.

Each embodiment will be described with a hardware block diagram. However, each embodiment may be achieved with software for all of or some portions of the hardware, which is a matter of design.

### First Embodiment

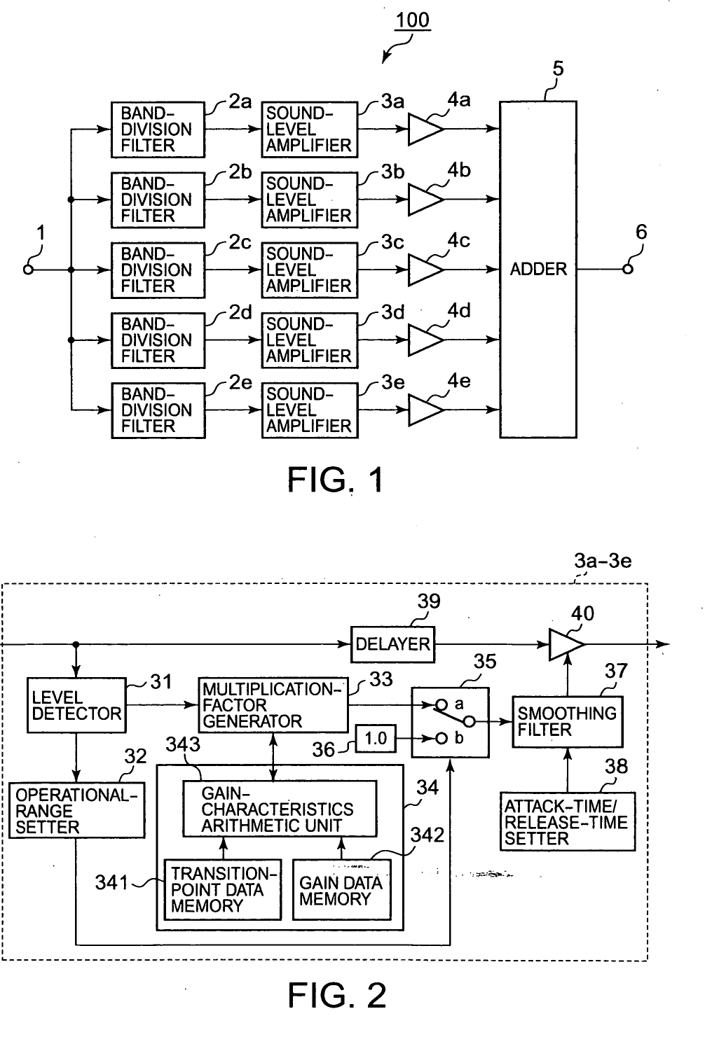

The block diagram shown in FIG. 1 represents a first embodiment of audio-signal processing apparatus. An audio-signal processing apparatus 100 shown in FIG. 1 has basic components essential for each embodiment.

In FIG. 1, a digital audio signal (a first audio signal) input via an input terminal 1 is supplied to band-division (band-pass) filters 2a to 2e with different frequency bands.

The frequency range for which human beings can hear is more or less 20 Hz to 20 kHz. In this range, the band-division filters 2a to 2e may, for example, be adjusted to allow the following bands to pass:

Filter 2a: a low frequency band such as from 20 Hz to 200 Hz;

Filter 2b: a low-to-intermediate frequency band such as from 200 Hz to 600 Hz;

Filter 2c: an intermediate frequency band such as from 600 Hz to 1.8 kHz;

Filter 2d: an intermediate-to-high frequency band such as from 1.8 kHz to 5.4 kHz; and

Filter 2e: a high frequency band such as from 5.4 kHz to 20 kHz.

The low-to-intermediate frequency band from 200 Hz to 600 Hz is a frequency range including fundamental frequencies of voice. The intermediate frequency band from 600 Hz to 1.8 kHz is a frequency range including formats. The intermediate-to-high frequency band from 1.8 kHz to 5.4 kHz is a frequency range including consonants.

The number of the band-division (band-pass) filters or how many frequency bands to which an audio signal is divided is a matter of design, thus not limited to five divisions shown in FIG. 1. For instance, in the case of three divisions, it is preferable to divide an audio signal into a low frequency band from 20 Hz to 200 Hz, an intermediate frequency band from 200 Hz to 5.4 kHz, and a high frequency band from 5.4 kHz to 20 kHz.

Connected to the output of respective band-division (band-pass) filters 2a to 2e are sound-level amplifiers 3a to 3e which are, typically, dynamic-range controllers. Each amplifier amplifies a sound level of an audio signal (a second audio signal) output by the corresponding band-division filter, as described later in detail. The amplifiers 3a to 3e have an identical circuitry but are adjusted to exhibit different sound-level amplification (or gain) characteristics. The gain characteristics may not necessarily be different for all of the amplifiers 3a to 3e but be the same for some of them.

Connected to the output of respective sound-level amplifiers 3a to 3e are amplifiers 4a to 4e. Each amplifier amplifies the audio signal output by the corresponding sound-level amplifier at a specific gain. The gain may be preset at the same level for all of the amplifiers 4a to 4e, at different levels for some of them or a specific level per frequency band. The audio signals output by the amplifiers 4a to 4e are supplied to an adder 5, added to each other, and output via an output terminal 6.

Sounds carried by an output audio signal (a third audio signal) of the adder 5 is given off by a speaker or headphones (not shown) to a listener. Although the amplifiers 4a to 4e have the function described above, they are not the essential components in the present invention, or they may be omitted which is a mater of design.

The sound-level amplifiers 3a to 3e with an identical circuitry will be described in detail with respect to FIG. 2.

In FIG. 2, the audio signal output by the band-division filter 2a, 2b, 2c, 2d or 2e is supplied to a level detector 31 and a delayer 39.

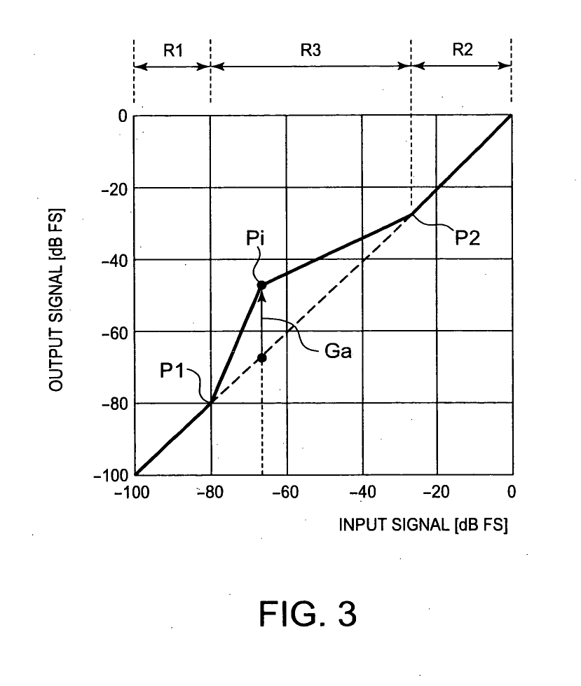

It is presupposed in this embodiment that an audio signal to be supplied to each of the sound-level amplifiers 3a to 3e has a sound level in the range from −100 dB FS to 0 dB FS (Full Scale), as shown in FIG. 3.

The level detector 31 detects a sound level of the input audio signal in the range from the lowest sound level of −100 dB FS to the highest sound level of 0 dB FS. The detected sound level is supplied to an operational-range setter 32 and a multiplication-factor generator 33.

FIG. 3 teaches two un-amplified ranges in which an input audio signal is preferably not amplified: a low sound-level range R1 from the lowest sound level of −100 dB FS to a specific level, such as, −80 dB FS; and a high sound-level range R2 from a specific level, such as, −25 dB FS to the highest sound level of 0 dB FS.

When an audio signal is not amplified within the low and high sound-level ranges R1 and R2, the music reproducibility for music carried by the audio signal is almost not degraded. The music reproducibility is defined that music can be reproduced as exactly as possible as created by musical artists. This is because amplification in the low range R1 gives much noise while in the high range R2 gives much distortion which is audibly remarkable due to higher sound level in this range.

Nevertheless, an audio signal may be amplified within the low and high sound-level ranges R1 and R2 at a certain level unless the music reproducibility is degraded remarkably.

An intermediate sound-level range R3 between the low and high ranges R1 and R2 is an amplified range. In FIG. 3, a dashed line and a solid line represent the input-to-output characteristics (gain characteristics) before and after amplified, respectively, in the range R3.

As discussed later in detail, the un-amplified and amplified ranges set at the operational-range setter 32 are unique to each of the sound-level amplifiers 3a to 3e.

In FIG. 2, connected to the multiplication-factor generator 33 is a gain-characteristics setter 34 that consists of a transition-point data memory 341, a gain data memory 342, and a gain-characteristics arithmetic unit 343.

As shown in FIG. 3, an input audio signal in the intermediate sound-level range R3 (an amplified range) is amplified in accordance with the following gain characteristics (1) and (2):

(1) The gain is higher as the sound level of the input audio signal is higher within a range from a point P1 to a point Pi. The point P1 (a first specific level) is the highest sound level in the low sound-level range R1 but the lowest sound level in the immediate sound-level range R3. The point Pi is a transition point in the intermediate sound-level range R3.

(2) The gain is lower as the sound level of the input audio signal is higher within a range from the transition point Pi to a point P2. The point P2 (a second specific level) is the highest sound level in the intermediate sound-level range R3 but the lowest sound level in the high sound-level range R2.

Shown in FIG. 3 is one example of the gain characteristics in which the gain is linearly higher from the point P1 to the transition Pi and then linearly lower from the transition point Pi to the point P2.

The transition-point data memory 341 has data on transition points Pi at several sound levels of an input audio signal. The gain data memory 342 has data on gains Ga at several transition points Pi. The transition-point (Pi) data and the gain (Ga) data are supplied to the gain-characteristics arithmetic unit 343. The Pi data indicates a location (an input sound level) of each transition point Pi. The Ga data determines the gain Ga, or indicates a multiplication factor by which the input sound level is multiplied at each transition point Pi, in this embodiment.

The gain-characteristics arithmetic unit 343 has lean data and multiplication-factor data. The lean data indicates an inclination of the gain characteristics on the lower and the higher sound-level side of each transition point Pi. The multiplication-factor data is obtained by calculation with the lean, Pi and Ga data, and used for obtaining the gain characteristics in the intermediate sound-level range R3.

The multiplication-factor generator 33 accesses the multiplication-factor data stored in the gain-characteristics arithmetic unit 343. Then, the generator 33 generates a multiplication-factor value in accordance with a sound level of the input audio signal supplied from the level detector 31.

The generated multiplication-factor value is supplied to a terminal “a” of a switch 35 at a terminal “a”. Supplied to a terminal “b” of the switch 35 is a value of 1.0 that is a fixed multiplication-factor value from a fixed multiplication-factor generator 36. Also supplied to the switch 35 is the operational-range data on the un-amplified and amplified ranges set at the operational-range setter 32. The switch 35 turns to the terminal “b” when the supplied data indicates the un-amplified range whereas the terminal “a” when the data indicates the amplified range. Then, the switch 35 generates gain data that indicates the gain characteristics according to which the input audio signal is amplified from the lowest to the highest sound level.

Also provided in this embodiment are a smoothing filter 37 and an attack-time/release-time setter 38. It is preferable to provide them, although not essential in the present invention. The setter 38 has attack- and release-time setting data. The smoothing filter 37 applies a smoothing procedure to the gain data supplied from the switch 35 in accordance the attack- and release-time setting data. The smoothing procedure with the attack- and release-time setting data will be described later in detail.

The input audio signal delayed by the delayer 39 is supplied to an amplifier 40. Also supplied to the amplifier 40 is the gain data from the smoothing filter 37 and applied with the smoothing procedure. The amplifier 40 amplifies the input audio signal based on the gain data from the smoothing filter 37. The amplified audio signal is then supplied to the corresponding amplifier 4a, 4b, 4c, 4d or 4e in FIG. 1.

The audio signal supplied to the amplifier 40 described above is the input audio signal delayed by the delayer 39 for a period required for the procedure performed by the level detector 31 to the smoothing filter 37. It is preferable to provide the delayer 39. Nevertheless, the delayer 39 is not essential in this invention. Audio signals output from the adder 5 (FIG. 1) are not degraded so much for listening without the delayer 39.

As described above, the sound-level amplifiers 3a to 3e amplify audio signals of the corresponding frequency bands in accordance with the respective gain characteristics.

Discussed next are the low, low-to-intermediate, intermediate, intermediate-to-high, and high frequency bands at the band-division filters 2a to 2e (FIG. 1), respectively.

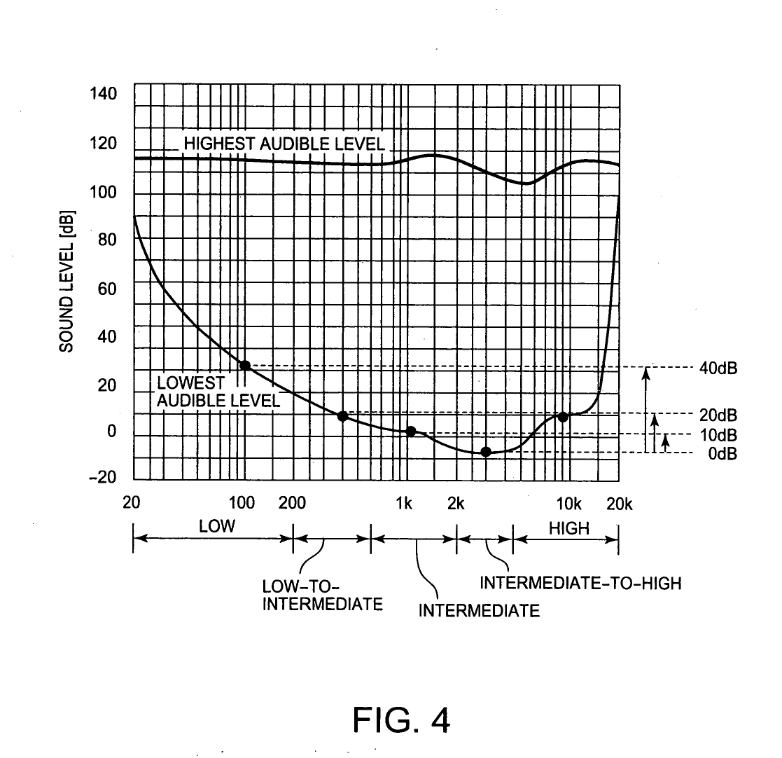

FIG. 4 shows the audible characteristics with an audible sound-level range in which ordinary people can hear sounds. An audible range covers sound levels between the lowest and highest audible levels. FIG. 4 teaches the lowest audible sound level depends on the frequency of audio signals. There is the most lowest audible sound level in the intermediate-to-high frequency band from 1.8 kHz to 5.4 kHz among the frequency bands.

In this embodiment, several types of gain characteristics are set at the sound-level amplifiers 3a to 3e for different lowest audible sound levels depending on the frequency bands.

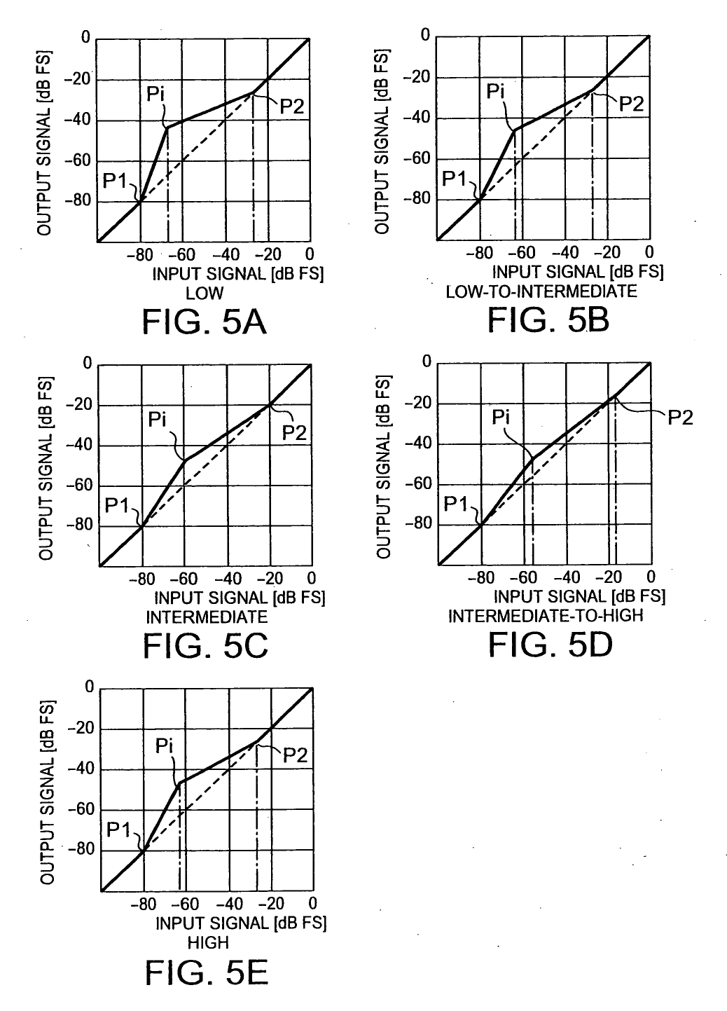

FIGS. 5A to 5E show several types of feasible gain characteristics for the sound-level amplifiers 3a to 3e.

FIG. 5A shows the gain characteristics for the sound-level amplifier 3a that covers the low frequency band from 20 Hz to 200 Hz, with the points P1 and P2 at −80 and −25 dBFS, respectively, and the transition point Pi at −66 dBFS.

FIG. 5B shows the gain characteristics for the sound-level amplifier 3b that covers the low-to-intermediate frequency band from 200 Hz to 600 Hz, with the points P1 and P2 at −80 and −25 dBFS, respectively, and the transition point Pi at −63 dBFS.

FIG. 5C shows the gain characteristics for the sound-level amplifier 3c that covers the intermediate frequency band from 600 Hz to 1.8 kHz, with the points P1 and P2 at −80 and −20 dBFS, respectively, and the transition point Pi at −60 dBFS.

FIG. 5D shows the gain characteristics for the sound-level amplifier 3d that covers the intermediate-to-high frequency band from 1.8 kHz to 5.4 kHz, with the points P1 and P2 at −80 and −28 dBFS, respectively, and the transition point Pi at −57 dBFS.

FIG. 5E shows the gain characteristics for the sound-level amplifier 3e that covers the high frequency band from 5.4 kHz to 20 kHz, with the points P1 and P2 at −80 and −25 dBFS, respectively, and the transition point Pi at −63 dBFS.

The point P1 is set at −80 dBFS for all of the frequency bands as shown in FIGS. 5A to 5E, which may, however, be set at different levels depending on the frequency bands.

FIGS. 5A to 5E show that the location of the transition point Pi on the gain characteristics curve depends on the sound-level amplifiers 3a to 3e. In detail, the transition point Pi is located at the lowest sound-level side (FIG. 5A) for the amplifier 3a. It is located at the next low sound-level side (FIGS. 5B and 5E) for the amplifiers 3b and 3e. The transition points Pi for the amplifiers 3b and 3e share the same location. However, it is also preferable to have slightly different Pi locations for the amplifiers 3b and 3e. The transition point Pi for the amplifier 3c is located at the higher sound-level side (FIG. 5C) than those for the amplifiers 3a, 3b and 3e. Located at the highest sound-level side (FIG. 5D) is the transition point Pi for the amplifier 3d.

Accordingly, the feasible locations for the transition point Pi in the five frequency bands shown in FIGS. 5A to 5E are as follows:

the highest sound-level side in the intermediate-to-high frequency band (FIG. 5D);

the lowest sound-level side in the low frequency band (FIG. 5A);

a higher side than the lowest sound-level side (FIG. 5A), in the low-to-intermediate frequency band (FIG. 5B);

a still higher side than the higher side (FIG. 5B), but a lower side than the highest side (FIG. 5D), in the intermediate frequency band (FIG. 5C); and

a lower side than the still higher side (FIG. 5C) and also the highest side (FIG. 5D), but a higher side than the lowest side (FIG. 5A), in the high frequency band (FIG. 5E).

Accordingly, a preferable relative Pi positional relationship is that the transition point Pi is located at the lowest, a lower, a higher, the highest, and a lower sound-level side in the low, the low-to-intermediate, the intermediate, the intermediate-to-high, and the high frequency band, respectively.

Moreover, in this embodiment, the gain Ga at the transition point Pi is set as unique to each of the sound-level amplifiers 3a to 3e as follows:

the highest for the amplifier 3a;

the lowest for the amplifier 3d;

the second highest (only lower than Ga of the amplifier 3a) for the amplifiers 3b and 3e; and

lower than Ga of the amplifiers 3b and 3e but higher than Ga of the amplifier 3d, for the amplifier 3c.

Accordingly, a preferable relative Ga level relationship is that the gain Ga is the highest, a higher, an intermediate, the lowest, and a higher level in the low, the low-to-intermediate, the intermediate, the intermediate-to-high, and the high frequency band, respectively. It is, however, possible to set the gain Ga at the same level in some of the frequency bands unless the music reproducibility is degraded remarkably.

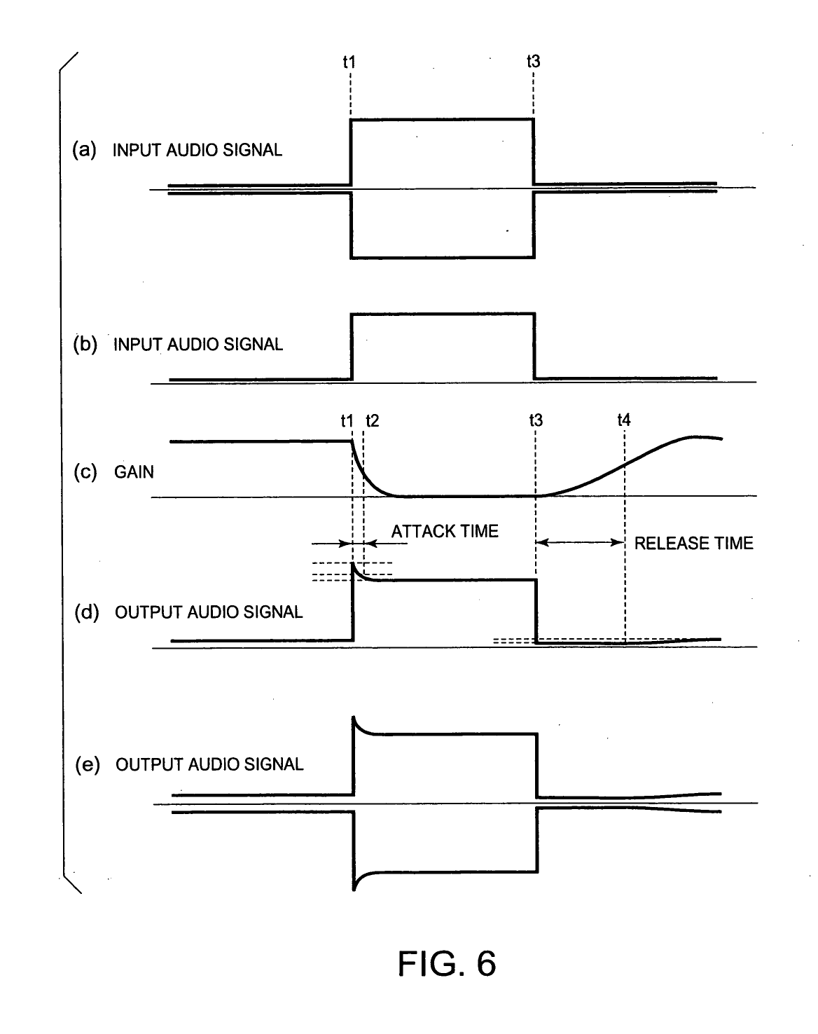

Discussed next with reference to FIG. 6 is a transient-response characteristics application procedure performed at the smoothing filter 37 and the attack-time/release-time setter 38 shown in FIG. 2.

Illustrated in (a) of FIG. 6 is a big change in the sound level of an input audio signal with a sign wave indicated with an envelope. The audio signal shown in (a) of FIG. 6 has a signal wave for which the sound level varies as follows: kept at −40 dBFS before a moment to; rapidly rises to −10 dBFS at the moment t1, that is kept up to a moment t3; rapidly falls to −40 dBFS at the moment t3; and kept at −40 dBFS after the moment t3. Illustrated in (b) of FIG. 6 is the signal in (a) of FIG. 6 at the positive side.

The smoothing filter 37 (FIG. 2) applies first and second transient-response characteristics to an audio signal, as follows:

The first transient-response characteristics is applied to an audio signal when the sound level varies from a first level to a second level higher than the first level in which the sound level is once raised from the first level to a level that exceeds the second level and then lowered to the second level.

The second transient-response characteristics is applied to an audio signal when the sound level varies from a third level to a fourth level lower than the third level in which the sound level is once lowered from the third level to a level that is below the fourth level and then raised to the fourth level.

Illustrated in (d) of FIG. 6 is the audio signal in (b) of FIG. 6 to which the first and second transient-response characteristics are applied.

There are an attack time and a release time in (d) of FIG. 6 which are defined as follows:

The attack time is defined as a period from a moment to at which the sound level is 100% to a moment t2 at which the sound level is lowered to a certain percent such as 50%. At the percent of 100%, the sound level rises to the highest level after it exceeds the second level (−10 dBFS) whereas at the percent of 0%, the sound level lowers to the second level, in the first transient-response characteristics discussed above. It is a matter of design for the attack time to set the moment t2 at any moment at which the sound level lowers by a certain percent such as 80% or 90%.

The release time is defined as a period from a moment t3 at which the sound level is 100% to a moment t4 at which the sound level is raised to a certain percent such as 50%. At the percent of 100%, the sound level lowers to the lowest level after it passes the fourth level (−40 dBFS) whereas at the percent of 100%, the sound level rises to the fourth level, in the second transient-response characteristics discussed above. It is a matter of design for the release time to set the moment t4 at any moment at which the sound level rises by a certain percent such as 80% or 100% (rises to 0%).

The first transient-response characteristics exhibits that the sound level lowers in a relatively short period. On the contrary, the second transient-response characteristics exhibits that the sound level rises in a relatively long period.

The attack time is set at a relatively short period such as ten to several ten milliseconds. On the contrary, the release time is set at a relatively long period such as 100 milliseconds or longer.

Illustrated in (c) of FIG. 6 is the change in gain. Multiplying the input audio signal in (b) of FIG. 6 by the gain in (c) of FIG. 6 gives an output audio signal shown in (d) of FIG. 6 and also in (e) of FIG. 6 which illustrates the output audio signal in the positive and negative sides.

The attack time and the release time are set by the attack-time/release-time setter 38 at a certain period. The combination of the smoothing filter 37 and the attack-time/release-time setter 38 applies the first or the second transient-response characteristics to an audio signal depending on the change in sound level, thus enhancing the music reproducibility with more natural sounds.

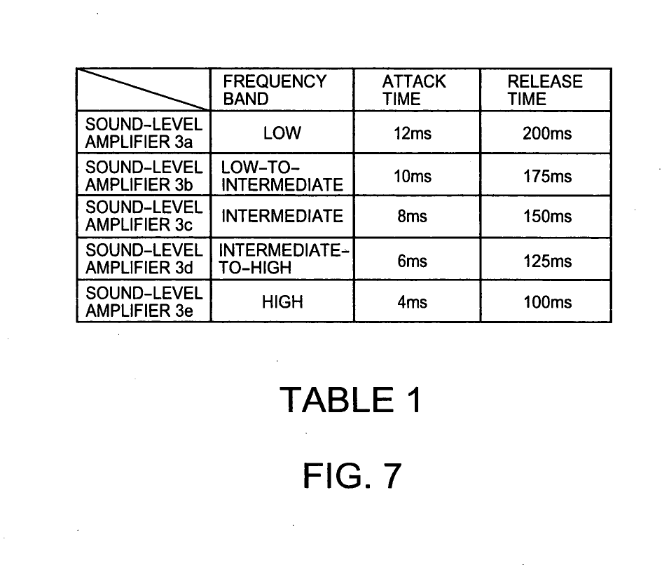

Listed in Table 1 of FIG. 7 are exemplary attack and release times for each of the sound-level amplifiers 3a to 3e.

In this embodiment, the attack-time/release-time setter 38 sets the attack and release times at a longer period in a lower frequency band whereas a shorter period in a higher frequency band for the sound-level amplifiers 3a to 3e. The attack and release time adjustments enhance the music reproducibility with more natural sounds than when the attack and release times are ser at the same period for all of the frequency bands.

### Second Embodiment

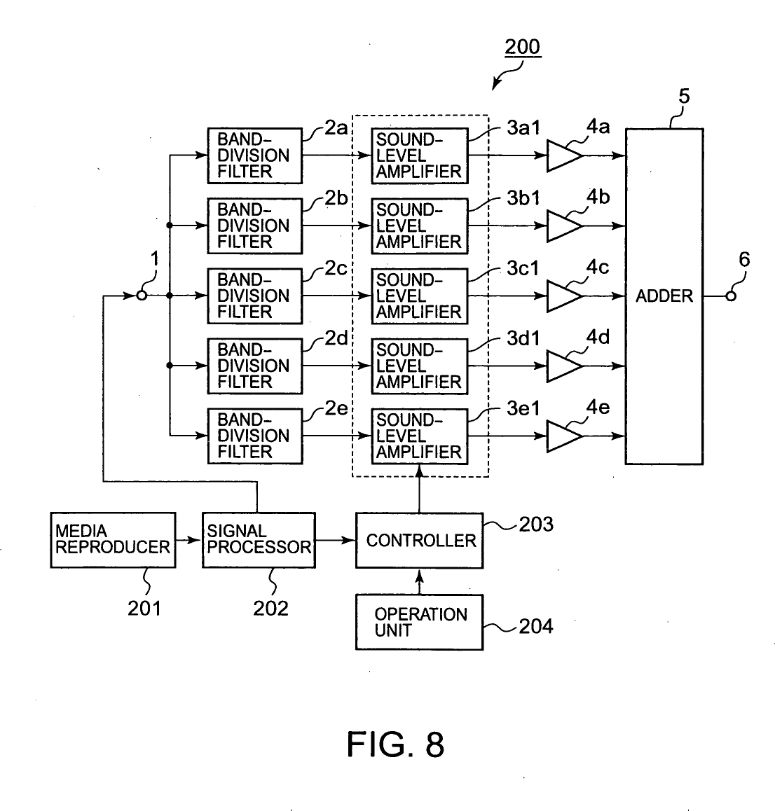

The block diagram shown in FIG. 8 represents a second embodiment of audio-signal processing apparatus. In an audio-signal processing apparatus 200 shown in FIG. 8, the same reference numerals are given to the elements identical or analogous to those of the counterpart 100 shown in FIG. 1, the detailed explanation thereof being omitted.

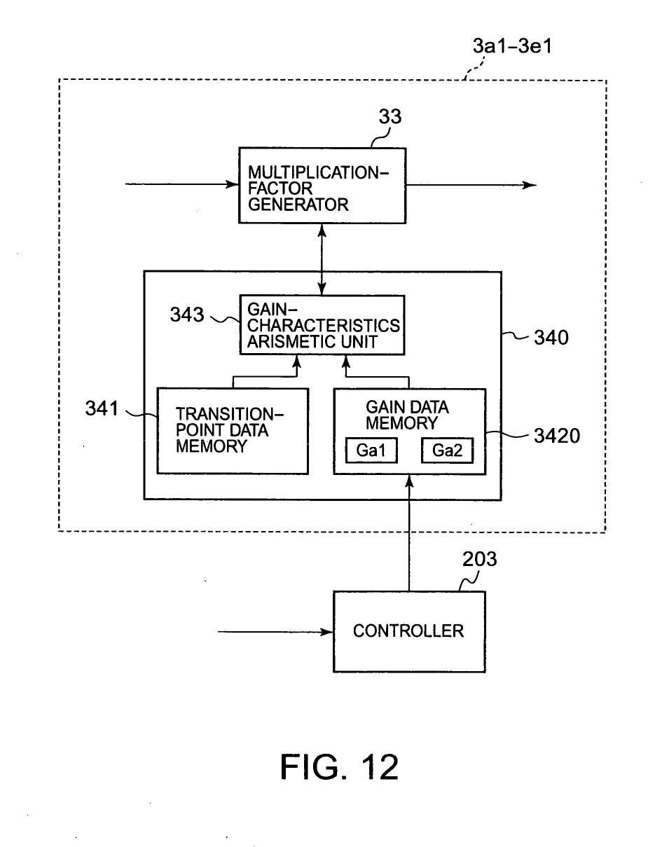

The audio-signal processing apparatus 200 features gain control in amplifying an audio signal at sound-level amplifiers 3a1 to 3e1 depending on the dynamic range of the audio signal. The gain to be controlled is the gain Ga at the transition point Pi (discussed in the first embodiment) set at a gain-characteristics setter 340 shown in FIG. 12, which will be described later.

In FIG. 8, a media reproducer 201 is a known optical-disc reproducer for use in optical-disc (CD, DVD, etc.) reproduction. A signal reproduced from an optical disc at the media reproducer 201 is supplied to a signal processor 202.

The signal processor 202 determines the type of optical disc based on the reproduced signal, in a known manner. The processor 202 extracts an audio signal from the reproduced signal and supplies it to the input terminal 1 and also supplies a disc-type signal to a controller 203.

The controller 203 controls the sound-level amplifiers 3a1 to 3e1 so that each amplifier can amplify an input audio signal at an optimum gain Ga in accordance with the dynamic range of the audio signal.

The dynamic range is about 98 dB for CD. It is about 120 dB for DVD. This is a practical dynamic rage for DVD although theoretical range is 140 dB or higher.

The feasible minimum and maximum gains Ga are about 6% and 20%, respectively, of the dynamic rage of an input audio signal at the sound-level amplifiers 3a1 to 3e1, which were experimentally found by the inventor of the present invention.

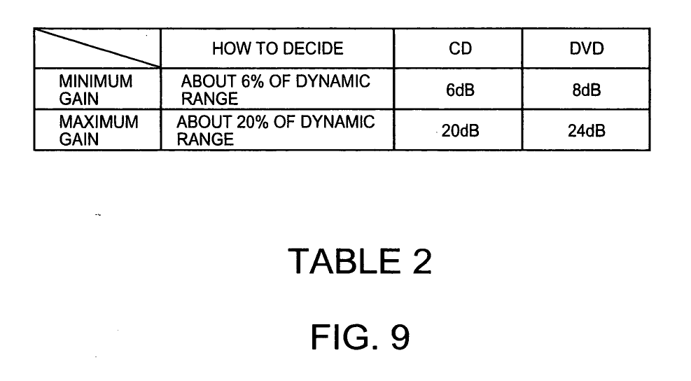

As shown in Table 2 of FIG. 9, the gain Ga is set at the sound-level amplifiers 3a1 to 3e1 in the range from: 6 dB (the minimum gain) to 20 dB (the maximum gain) for CD; and 8 dB (the minimum gain) to 24 dB (the maximum gain) for DVD.

The audio signal subjected to reproduction at the media reproducer 201 may not necessarily be a signal retrieved from an optical disc. It may be audio signal compressed with MP3 (MPEG Layer 3) or WMA (Windows Media Audio), a registered trademark, and stored in a semiconductor memory.

The dynamic range of a signal depends on resolution. A signal of 8 bits in resolution has 48 dB in dynamic range. A signal of 12 bits in resolution has 72 dB in dynamic range. Such resolution data is supplied to the controller 203 from the signal processor 202, in this embodiment.

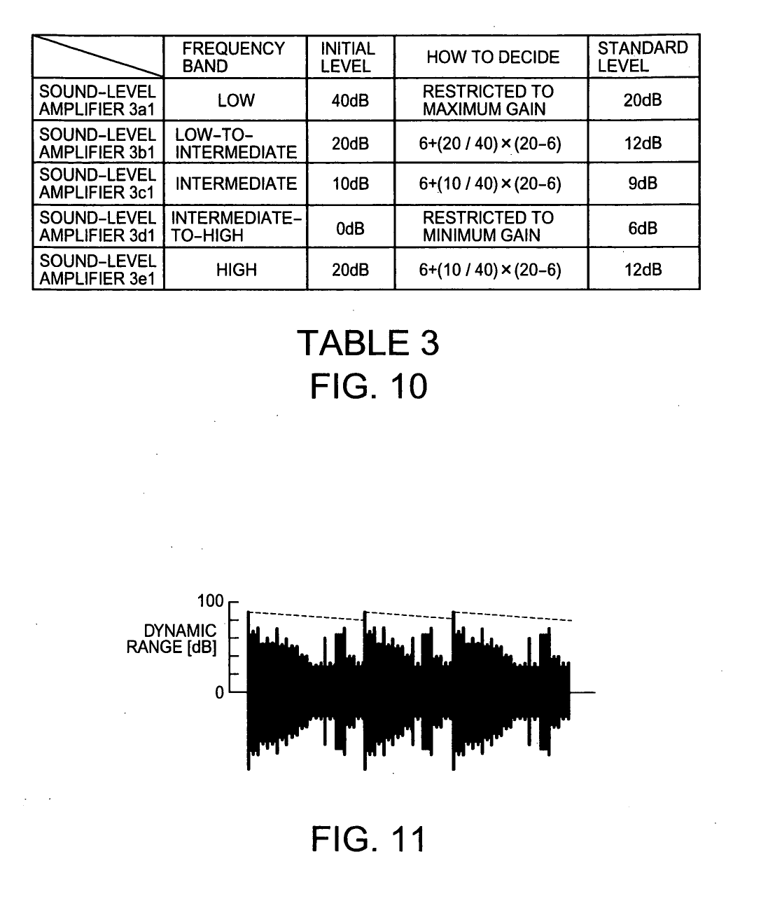

Discussed next with respect to Table 3 of FIG. 10 is exemplary gains Ga for CD, set at the sound-level amplifiers 3a1 to 3e1, with the minimum and maximum gains shown in Table 2 of FIG. 9.

The initial level of the gain Ga shown in Table 3 of FIG. 10 is set for each of the sound-level amplifiers 3a1 to 3e1 based on the lowest audible sound-level characteristic curve shown in FIG. 4.

The symbols “”plotted on the lowest audible sound-level characteristic curve in FIG. 4 indicate a representative of audible sound levels each being the lowest at respective frequencies in each frequency band. In each frequency band, the representative “” is situated at an almost middle point on the lowest audible sound-level characteristic curve.

FIG. 4 shows about 10 dB in the difference of the representative “” between the intermediate-to-high and the intermediate frequency band. It is about 20 dB between the intermediate-to-high and the low-to-intermediate frequency band and also between the intermediate-to-high and the high frequency band. Moreover, it is about 40 dB between the intermediate-to-high and the low frequency band.

Accordingly, the initial level in Table 3 of FIG. 10 is set at the difference in the representative “” of the lowest audible sound level between the intermediate-to-high frequency band (the benchmark) and each of the other frequency bands.

The standard level in Table 3 is the gain Ga calculated according to a formula (1) shown below, based on the minimum and maximum gains set as shown in Table 2 of. FIG. 9 and the difference in the lowest audible sound level in each frequency band, except for the low and the intermediate-to-high frequency band.

In detail, in the sound-level amplifier 3a1 for the low frequency band, the standard level Ga is set at 20 dB that is the maximum gain for CD in Table 3 of FIG. 10, against the initial level of 40 dB higher than 20 dB.

In the sound-level amplifier 3d1 for the intermediate-to-high frequency band, the standard level Ga is set at 6 dB that is the minimum gain for CD in Table 3, against the initial level of 0 dB lower than 6 dB.

For the sound-level amplifiers 3b1, 3c 1, and 3e1, the standard gain Ga is calculated according to:

Gamin+(Gin/Ginmax)×(Gamax−Gamin) (1)

In the formula (1), Gamin, Gamax, Gin, and Ginmax indicate the minimum gain, the maximum gain, the initial gain in a given frequency band, and the maximum in all of the initial gains, respectively.

According to the formula (1):

in the sound-level amplifier 3b1 for the low-to-intermediate frequency band, the standard level Ga is set at 12 dB against the initial gain of 20 dB;

in the sound-level amplifier 3c 1 for the intermediate frequency band, the standard level Ga is set at 9 dB against the initial gain of 10 dB; and0

in the sound-level amplifier 3e1 for the high frequency band, the standard level Ga is set at 12 dB against the initial gain of 20 dB.

The dynamic range is determined based on the type of storage medium or resolution in the second embodiment. It may, however, be directly determined from audio signals.

Shown in FIG. 11 is an exemplary waveform of an audio signal, which illustrates determination of the dynamic range. A signal level captured at a particular moment is lowered toward the zero level with a relatively long time constant. The same is repeated whenever a higher signal level is captured while the former signal level is being lowered. This is repeated for a particular period to determine the highest and lowest signal levels. The difference between the highest and lowest signal levels is calculated to give the dynamic range. The circuitry to perform these processes can be implemented in the audio-signal processing apparatus 200 shown in FIG. 8.

Moreover, several dynamic-range modes may be prepared and selected by a user via an operation unit 204 (FIG. 8) which may be implemented in audio equipment or may be a remote controller.

Shown in FIG. 12 is an exemplary block diagram of each of the sound-level amplifiers 3a1 to 3e1. The difference between the amplifiers 3a1 to 3e1 in the second embodiment and the counterparts 3a to 3e in the first embodiment shown in FIG. 2 is the gain-characteristics memory. A gain-characteristics memory 3420 of a gain-characteristics setter 340 in the second embodiment has a table of data on gains Ga1 and Ga2. The other elements are identical between the first and second embodiment, so that the multiplication-factor generator 33 and the gain-characteristics setter 340 are only shown in FIG. 12.

The data on gains Ga1 and Ga2 stored in the table of the gain-characteristics memory 3420 (FIG. 12) are for use in CD and DVD, respectively, that are exemplary optical discs subjected to reproduction by the media reproducer 201 (FIG. 7).

The gain-characteristics memory 3420 supplies the data on gain Ga1 for CD or Ga2 for DVD to the gain-characteristics arithmetic unit 343 under control by the controller 203, in FIG. 12.

Several gain-data (Ga1, GA2) pairs can be stored in the table gain-characteristics memory 3420 depending on the dynamic-rage modes at each of the sound-level amplifiers 3a1 to 3e1. Or, a benchmark gain-data (Ga1, GA2) pair may only be stored in the table for calculation of several gain-data pairs depending on the dynamic-rage modes. The gain-data (Ga1, GA2) pairs are selectable depending on the dynamic-rage modes under control by the controller 203.

### Third Embodiment

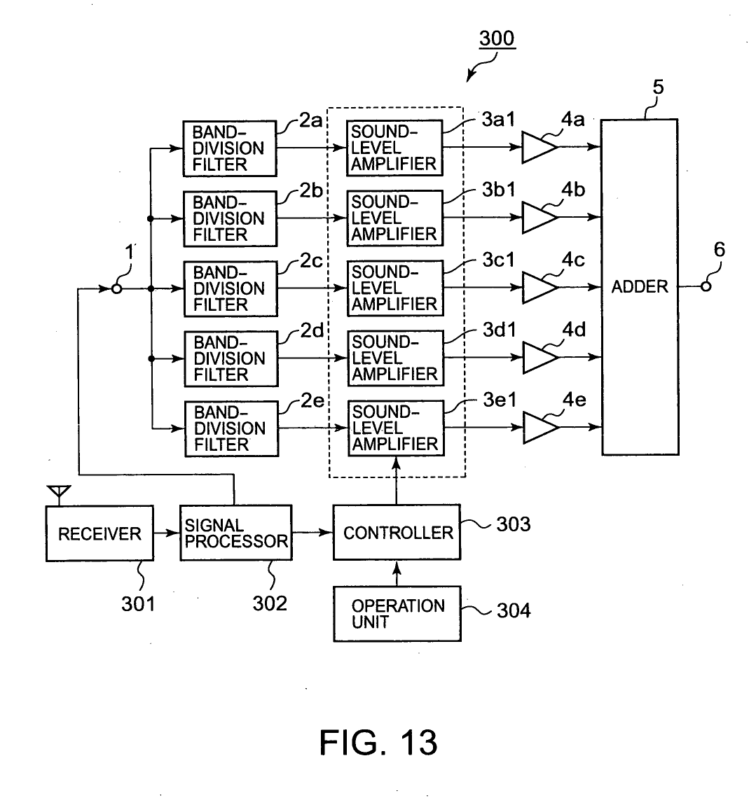

The block diagram shown in FIG. 13 represents a third embodiment of audio-signal processing apparatus. In an audio-signal processing apparatus 300 shown in FIG. 13, the same reference numerals are given to the elements identical or analogous to those of the counterpart 100 shown in FIG. 1 or the counterpart 200 shown in FIG. 8, the detailed explanation thereof being omitted.

The audio-signal processing apparatus 300 features gain control in amplifying an audio signal at the sound-level amplifiers 3a1 to 3e1, with the gain Ga set depending on the genres of the contents carried by audio signals.

The audio-signal processing apparatus 300 is equipped with a receiver 301 for receiving digital broadcast signals, as shown in FIG. 13.

A digital broadcast signal received by the receiver 301 is supplied to a signal processor 302. Extracted from the broadcast signal by the processor 302 are contents data involving video and audio signals, and auxiliary data added to the contents data and including contents-genre data. The audio signal in the contents data is supplied to the input terminal 1. The contents-genre data is supplied to a controller 303. Video-signal processing is omitted from the disclosure because it is not essential element of the present invention.

The controller 303 controls the sound-level amplifiers 3a1 to 3e1 in accordance with the contents-genre data. Each amplifier sets the Gain Ga at an optimum level depending on the genre of the contents carried by the audio signal and indicated by the contents-genre data.

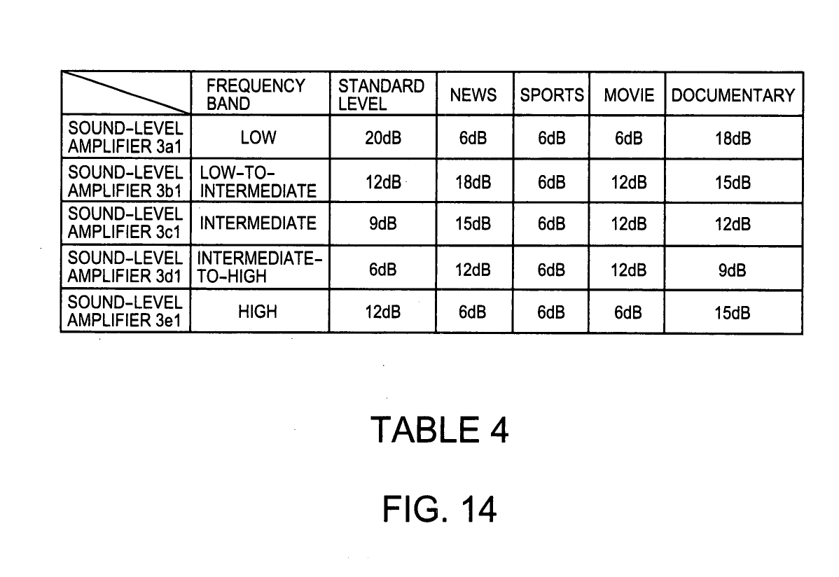

Listed in Table 4 shown in FIG. 14 are several levels of the gain Ga settable at the sound-level amplifiers 3a1 to 3e1 depending on the genre of the contents carried by the audio signal.

The standard level of the gain Ga in Table 4 for each of the sound-level amplifiers 3a1 to 3e1 is the same as that in Table 3 (FIG. 10). The gain Ga is varied depending on the genre of the contents against the standard level to achieve sounds reproduced naturally for each genre, in the third embodiment.

The several gains Ga listed for the respective genres of the contents were experimentally obtained.

Instead of the receiver 301 to receive digital broadcast signals, the audio-signal processing apparatus 300 may be equipped with a media reproducer like that shown in FIG. 8. Moreover, the apparatus 300 may be equipped with an operation unit 304 via which a user can select a genre.

Furthermore, the third embodiment can be combined with the second embodiment such that several dynamic-range modes are prepared for the genres shown in Table 4 (FIG. 14) and can be selected at each of the sound-level amplifiers 3a1 to 3e1.

### Fourth Embodiment

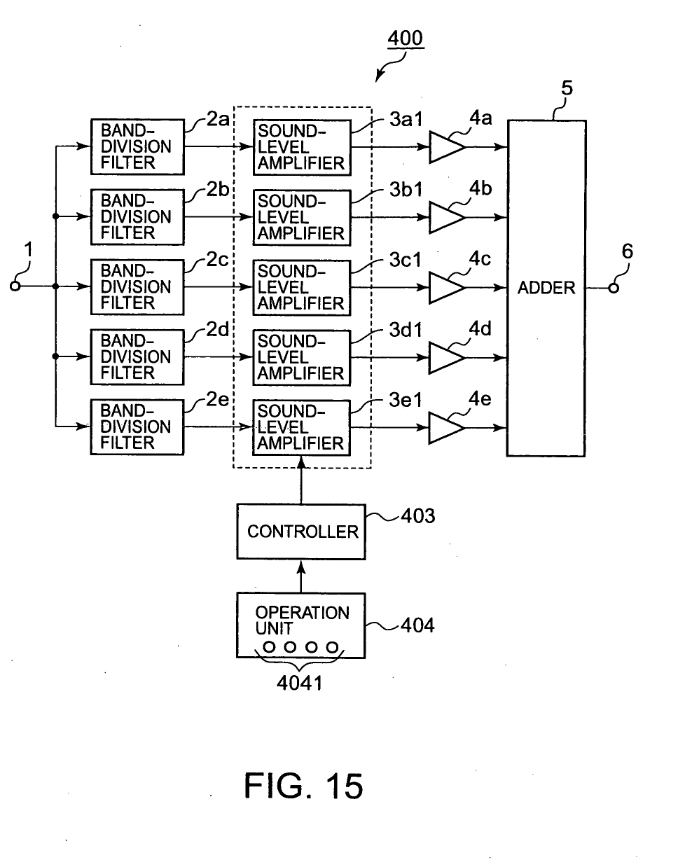

The block diagram shown in FIG. 15 represents a fourth embodiment of audio-signal processing apparatus. In an audio-signal processing apparatus 400 shown in FIG. 15, the same reference numerals are given to the elements identical or analogous to those of the counterpart 100 shown in FIG. 1 or the counterpart 200 shown in FIG. 8, the detailed explanation thereof being omitted.

The audio-signal processing apparatus 400 features gain control in amplifying an audio signal at the sound-level amplifiers 3a1 to 3e1, with the gain Ga set in accordance with the listening mode set by a user.

The audio-signal processing apparatus 400 is equipped with an operation unit 404 via which a user can select a listening mode among several modes, such as, normal, relaxing, BGM, and hearing aid. Depending on the selected mode, a controller 403 controls the sound-level amplifiers 3a1 to 3e1 so that each amplifier can amplify an input audio signal at an optimum gain Ga in accordance with the selected listening mode.

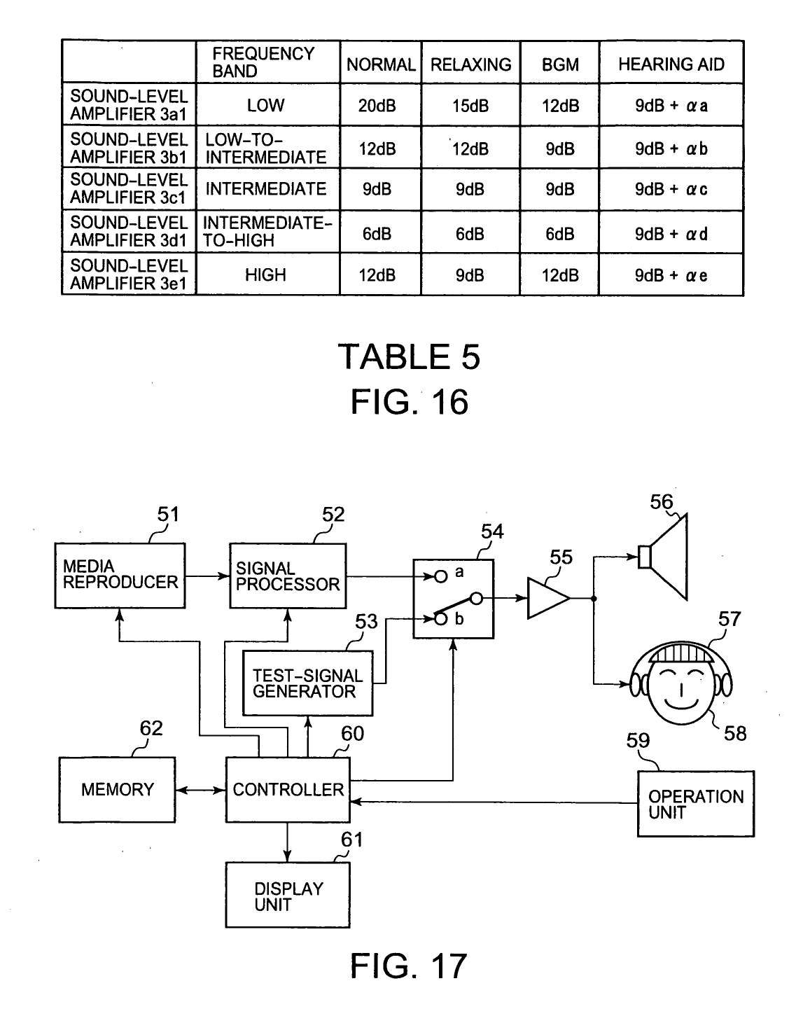

Listed in Table 5 shown in FIG. 16 are several levels of the gain Ga settable at the sound-level amplifiers 3a1 to 3e1 depending on the listening mode.

The level of the gain Ga in the normal mode in Table 5 for each of the sound-level amplifiers 3a1 to 3e1 is set at the standard level in Table 3 (FIG. 10).

The relaxing mode is prepared for listening to music comfortably. The BGM mode is prepared for listening to music at a lower sound level as background music. For such purposes, the gain Ga is set at a level lower than the normal level at some frequency bands in the relaxing and BGM mode.

The hearing-aid mode is prepared for adjusting the gain Ga with variants “αa”, “αb”, “αc”, “αd”, and “αe” which are set based on the individual auditory characteristics. Measurements of the auditory characteristics will be discussed later. The gain adjustments with (9 dB+αa), (9 dB+αb), (9 dB+αc), (9dB+αd), and (9 dB+αe) at the the sound-level amplifiers 3a1 to 3e1, respectively, enhance the audibility in the several frequency bands, which depends on each listener.

In the first to fourth embodiments as disclosed above, the gain Ga is set based on the lowest audible level in the audible characteristics of ordinary people. Below the lowest level, ordinary people cannot hear sounds. Thus, setting the gain Ga based on the lowest level achieves reproduction of sounds audibly optimum to each listener.

FIG. 17 shows an exemplary block diagram of auditory-characteristics measuring equipment.

An audio signal is reproduced from a given storage medium at a media reproducer 51. The reproduced audio signal is processed by a signal processor 52 and supplied to a terminal “a” of a switch 54. The processed audio signal is amplified by an amplifier 55 and then supplied to a speaker 56 or a headphone set 57 when the switch 54 is at the terminal “a” side under control by a controller 60. This is a music reproduction process at ordinary audio equipment.

A test-signal generator 53 generates a test signal for measurements of the auditory characteristics of a listener. The test signal may be recorded on an optical storage medium, such as, CD, and reproduced by the media reproducer 51.

The test signal is supplied to a terminal “b” of the switch 54. It is supplied to the speaker 56 or the headphone set 57, via the amplifier 55, when the switch 54 is at the terminal “b” side under control by the controller 60.

A listener who measures his or her auditory characteristics listens to the test signal given off by the speaker 56 or the headphone set 57. The test signal involves an audio signal selectable over the frequency band ranging from 20 Hz to 20 kHz. While listening to the audio signal in the frequency band which the listener selects via an operation unit 59, the listener adjusts the sound level via the operation unit 59 to find out the lowest audible sound level.

In detail, when the listener selects a frequency band via the operation unit 59, the controller 60 controls the test-signal generator 53 to generate a test signal in the selected frequency band. The listener finds out the lowest audible sound level in each of several frequency bands. An image or a message is displayed on a display unit 61 for the guidance on auditory-characteristics measurements.

The lowest audible sound-level data in the several frequency bands and found out through the-operation of the operation unit 59 are stored in a memory 62 as the listener's own lowest audible sound-level data under control by the controller 60.

The signal processor 52 is equipped with the audio-signal processing apparatus 100, 200, 300 or 400 disclosed in the first, the second, the third and the fourth embodiment, respectively. The controller 60 accesses the lowest audible sound-level data stored in the memory 62 for the listener and controls the signal processor 52, or the audio-signal processing apparatus 100, 200, 300 or 400 to work as described in the first, second, third and fourth embodiment, respectively.

As disclosed above in detail, according to the audio-signal processing apparatus and method of the present invention, the invention can offer sounds reproduced at an appropriate sound level without degrading music reproducibility. Therefore, the present invention can offer audio equipment via which a listener can enjoy music without being tired of listening.

It is further understood by those skilled in art that the foregoing description is a preferred embodiment of the disclosed device or method and that various changes and modifications may be made in the invention without departing from the sprit and scope thereof.

What is claimed is:

1. An audio signal processing apparatus comprising:
band-division filters that divide a first audio signal into a plurality of frequency bands and output second audio signals in the respective frequency bands;
sound-level amplifiers that amplify the second audio signals in the respective frequency bands in accordance with gain characteristics that covers a sound-level range from a lowest sound level to a highest sound level of each second audio signal, the sound-level range having a low sound level range from the lowest sound level to a first specific sound level, a high sound level range from a second specific sound level to the highest sound level, and an intermediate sound-level range from the first to second specific sound levels between the low and high sound level ranges, the intermediate sound-level range having a transition point having a sound level higher than the first specific sound level but lower than the second specific sound level, in which each second audio signal is amplified by the corresponding sound-level amplifier such that a sound level of each second audio signal is increased from the first specific sound level to the sound level of the transition point and then lowered from the sound level of the transition point to the second specific sound level in the intermediate sound-level range in accordance with the gain characteristics, and
an adder to add the second audio signals thus amplified and output the added second audio signals as a third audio signal.

2. The audio signal processing apparatus according to claim 1, wherein the transition point is located differently in the intermediate sound-level range in at least some of the frequency bands.

3. The audio signal processing apparatus according to claim 2, wherein the transition point is located as closest to the second specific sound level in a specific frequency band that covers the most lowest audible sound level among the frequency bands.

4. The audio signal processing apparatus according to claim 2, wherein the transition point is located as closest to the first specific sound level in the lowest band among the frequency bands.

5. The audio signal processing apparatus according to claim 1, wherein the sound-level amplifiers amplify the second audio signals at specific gains, the gains at the transition point being different in at least some of the frequency bands.

6. The audio signal processing apparatus according to claim 5, wherein a gain at the transition point is minimum in a frequency band that covers the most lowest audible sound level among the frequency bands.

7. The audio signal processing apparatus according to claim 5, wherein a gain at the transition point is maximum in the lowest band among the frequency bands.

8. The audio signal processing apparatus according to claim 5, wherein a gain at the transition point is set in a range from minimum to maximum gains calculated based on a dynamic range of the first audio signal.

9. The audio signal processing apparatus according to claim 8, wherein the first audio signal is one of a plurality of audio signals having different dynamic ranges, a plurality of gain pairs being prepared at each sound-level amplifier for the dynamic ranges, the pairs being selectable depending on the dynamic range of the first audio signal.

10. The audio signal processing apparatus according to claim 5, wherein the first audio signal is one of a plurality of audio signals carrying contents of different genres, a plurality of gains at the transition point being prepared at each sound-level amplifier for the genres, the gains being selectable depending on the contents of a genre carried by the first audio signal.

11. The audio signal processing apparatus according to claim 5, wherein a plurality of gains at the transition point are prepared at each sound-level amplifier in accordance with a plurality of listening modes for listening the third audio signal, the gains being selectable depending on a listening mode set by a listener.

12. The audio signal processing apparatus according to claim 1, wherein each sound-level amplifier applies first and second transient-response characteristics to the corresponding second audio signal, wherein
the first transient-response characteristics has an attack time having a first period and is applied to the second audio signal at a moment at which the second audio signal rises from a first sound level to a second sound level, and
the second transient-response characteristics has a release time having a second period and is applied to the second audio signal at a moment at which the second audio signal falls from a third sound level to a fourth sound level, the second period being longer than the first period.

13. The audio signal processing apparatus according to claim 12, wherein each sound-level amplifier applies the first and second transient-response characteristics to the second audio signal with the first and second periods, respectively, each period being shorter for a higher frequency band.

14. The audio signal processing apparatus according to claim 3, wherein the lowest audible sound level is determined based on audible characteristics of ordinary human beings.

15. The audio signal processing apparatus according to claim 3, wherein the lowest audible sound level is determined based on pre-measured audible characteristics of a listener to the third audio signal.

16. An audio signal processing method comprising the steps of:
dividing a first audio signal into a plurality of frequency bands and outputting second audio signals in the respective frequency bands;
amplifying the second audio signals in the respective frequency bands in accordance with gain characteristics that covers a sound-level range from a lowest sound level to a highest sound level of each second audio signal, the sound-level range having a low sound level range from the lowest sound level to a first specific sound level, a high sound level range from a second specific sound level to the highest sound level, and an intermediate sound-level range from the first to second specific sound levels between the low and high sound level ranges, the intermediate sound-level range having a transition point having a sound level higher than the first specific sound level but lower than the second specific sound level, in which each second audio signal is amplified in the corresponding frequency band such that a sound level of each second audio signal is increased from the first specific sound level to the sound level of the transition point and then lowered from the sound level of the transition point to the second specific sound level in the intermediate sound-level range in accordance with the gain characteristics, and
adding the second audio signals thus amplified and outputting the added second audio signals as a third audio signal.

17. The audio signal processing method according to claim 16, wherein the transition point is located differently in the intermediate sound-level range in at least some of the frequency bands.

18. The audio signal processing method according to claim 16, wherein the transition point is located as closest to the second specific sound level in a specific frequency band that covers the most lowest audible sound level among the frequency bands.

19. The audio signal processing method according to claim 17, wherein the transition point is located as closest to the first specific sound level in the lowest band among the frequency bands.

20. The audio signal processing method according to claim 16, wherein the second audio signals are amplified at specific gains, the gains at the transition point being different in at least some of the frequency bands.

21. The audio signal processing method according to claim 20, wherein a gain at the transition point is minimum in a frequency band that covers the most lowest audible sound level among the frequency bands.

22. The audio signal processing method according to claim 20, wherein a gain at the transition point is maximum in the lowest band among the frequency bands.

23. The audio signal processing method according to claim 20, wherein a gain at the transition point is set in a range from minimum to maximum gains calculated based on a dynamic range of the first audio signal.

24. The audio signal processing method according to claim 23, wherein the first audio signal is one of a plurality of audio signals having different dynamic ranges, a plurality of gain pairs being prepared at each frequency band for the dynamic ranges, the pairs being selectable depending on the dynamic range of the first audio signal.

25. The audio signal processing method according to claim 20, wherein the first audio signal is one of a plurality of audio signals carrying contents of different genres, a plurality of gains at the transition point being prepared at each frequency band for the genres, the gains being selectable depending on the contents of a genre carried by the first audio signal.

26. The audio signal processing method according to claim 20, wherein a plurality of gains at the transition point is prepared at each frequency band in accordance with a plurality of listening modes for listening the third audio signal, the gains being selectable depending on a listening mode set by a listener.

27. The audio signal processing method according to claim 16, wherein each second audio signal is applied with first and second transient-response characteristics when the second audio signal is amplified, wherein
the first transient-response characteristics has an attack time having a first period and is applied to the second audio signal at a moment at which the second audio signal rises from a first sound level to a second sound level, and
the second transient-response characteristics has a release time having a second period and is applied to the second audio signal at a moment at which the second audio signal falls from a third sound level to a fourth sound level, the second period being longer than the first period.

28. The audio signal processing method according to claim 27, wherein the second audio signal is applied with the first and second transient-response characteristics with the first and second periods, respectively, each period being shorter for a higher frequency band.

29. The audio signal processing method according to claim 18, wherein the lowest audible sound level is determined based on audible characteristics of ordinary human beings.

30. The audio signal processing method according to claim 18, wherein the lowest audible sound level is determined based on pre-measured audible characteristics of a listener to the third audio signal.
